(19) United States
(12) Patent Application Publication
(10) Pub. No.: US 2013/0143489 A1
(43) Pub. Date: Jun. 6, 2013

(54) NEAR FIELD COMMUNICATION EQUIPPED DEVICE

(71) Applicants: Paul Morris, Cambridge (GB); Hendrik Strauss, Cambridgeshire (GB)

(72) Inventors: Paul Morris, Cambridge (GB); Hendrik Strauss, Cambridgeshire (GB)

(73) Assignee: Cambridge Silicon Radio Limited, Cambridge (GB)

(21) Appl. No.: 13/328,311

(22) Filed: Dec. 16, 2011

(30) Foreign Application Priority Data
Dec. 1, 2011 (GB) GB1120719.8

(51) Int. Cl. H04B 5/00; H04W 88/02

(52) U.S. Cl. 455/41.1

(57) ABSTRACT

The present application relates to a near field communication (NFC) equipped device such as a mobile telephone. The device includes an NFC controller for controlling NFC operations of the device and a secure element for NFC applications and sensitive data. The secure element includes non-volatile memory which is used by the device to store non-volatile NFC data. The non-volatile NFC data is transferred between the secure element and the NFC controller by means of a single wire protocol interface and dedicated proprietary gates of a host controller interface, which dedicated gates are used for transferring the non-volatile NFC data to the secure element memory and retrieving the non-volatile NFC data from the secure element memory.

### CROSS-REFERENCE TO RELATED APPLICATIONS

This application claims priority to United Kingdom Patent Application Number GB1120719.8 filed Dec. 1, 2011, entitled “A Near Field Communication Equipped Device,” the entire disclosure of which is hereby incorporated by reference, for all purposes, as if fully set forth herein.

### TECHNICAL FIELD

The present application relates to a near field communication (NFC) device.

### BACKGROUND TO THE INVENTION

Near field communication (NFC) systems are becoming increasingly prevalent in communications devices such as mobile telephones. In one mode of operation, known as card emulation mode, the NFC system in a device such as a mobile telephone enables short range communication between the device and an external NFC reader to facilitate contactless data exchange between the device and the reader, in applications such as cashless payment, electronic ticketing and access for public transport and the like.

In order to support such NFC functionality a device must include an NFC system. An exemplary NFC equipped device is illustrated in schematic form in FIG. 1. In this example the device is shown as a mobile telephone 10, and includes an NFC controller 12 which is operatively connected to an application processor 14 of the telephone 10). The application processor 14 is also connected to and communicates with a universal integrated circuit card(UICC) 16 (sometimes also referred to as a subscriber identity module or SIM), whilst the NFC controller 12 communicates with the UICC 16 using a single wire protocol (SWP) interface which implements a host controller interface (HCI) between the UICC 16 and the NFC controller 12.

The UICC 16 contains memory and data such as account information required for operation of the mobile telephone 10, and includes a secure element (SE) 18, which is a secure processor with an associated area of memory that is used for securely storing NFC applications and sensitive data, for example credit card details.

A typical NFC equipped mobile telephone such as the one shown in FIG. 1 also includes non-volatile memory 20 for storing non-volatile operational data required by the NFC controller 12 in order to allow access to the UICC when no power is available from the mobile telephone platform (battery OFF mode). Such data may include HCI gate information for accessing the UICC.

The non-volatile memory 20 may be provided as part of the NFC controller 12, in which case the silicon area required for the NFC controller 12 is increased. Alternatively, the non-volatile memory 20 may be provided as dedicated off-chip memory, in which case an additional non-volatile memory component is required, which adds to the bill of materials (BoM) cost of the device 10.

### SUMMARY OF INVENTION

The present application relates to a near field communication (NFC) equipped device such as a mobile telephone. The device includes an NFC controller for controlling NFC operations of the device and a secure element for NFC applications and sensitive data. The secure element includes non-volatile memory which is used by the device to store non-volatile NFC data. The non-volatile NFC data is transferred between the secure element and the NFC controller by means of a single wire protocol interface and dedicated proprietary gates of a host controller interface, which dedicated gates are used for transferring the non-volatile NFC data to the secure element memory and retrieving the non-volatile NFC data from the secure element memory. Using the secure element memory in this way obviates the need for non-volatile memory associated with the NFC controller, which reduces the silicon area of the NFC controller and the bill of materials cost of the device.

According to a first aspect of the present invention there is provided a near field communications (NFC) equipped device comprising: an NFC controller for controlling NFC communication between the device and a compatible NFC reader; a secure element for storing NFC applications and data; and a single wire protocol interface for communication between the NFC controller and the secure element, wherein the NFC controller is configured to use the single wire protocol to write non-volatile NFC data to memory of the secure element and to read the non-volatile NFC data from the memory of the secure element.

The secure element may implement a dedicated gate for transferring the non-volatile NFC data to and from the memory of the secure element.

The NFC controller may implement a dedicated gate for transferring the non-volatile NFC data to and from the memory of the secure element.

The NFC equipped device may comprise a mobile telephone.

The secure element may be provided on a universal integrated circuit card (UICC), for example. Alternatively the secure element may be provided in an embedded secure element e.g. a secure element which is contained within the same package as or adjacent to the NFC controller.

According to a second aspect of the invention there is provided a method of retrieving non-volatile NFC data from memory of a secure element of a NFC equipped device according to the first aspect of the invention, the method comprising: sending a modified message from the NFC controller to the secure element to indicate that the NFC controller supports retrieval of the non-volatile NFC data from the memory of the secure element; and at the secure element, receiving the modified message and responding by transmitting the non-volatile NFC data to the NFC controller.

The modified message may be an “ACT_POWER_MODE” message whose FR bit is set to 1.

The non-volatile NFC data may be transmitted to the NFC controller as a plurality of data packets followed by an “ACT_READY” message.

According to a third aspect of the invention there is provided a secure element for use in an NFC equipped device, the secure element including non-volatile memory, wherein the secure element implements a dedicated gate for transferring non-volatile NFC data to and from the non-volatile memory of the secure element.

According to a fourth aspect of the invention there is provided a secure element for use in an NFC equipped device, wherein the secure element is configured to defer booting up its main operating system for a period sufficient to permit retrieval of non-volatile data from the secure element within a predetermined time period.

The predetermined time period may be 5 milliseconds.

The secure element may be configured to defer booting up its main operating system until it receives a message indicating that the non-volatile data has been retrieved from the secure element.

The message may be a ANY_GET_PARAMETER message, for example.

### BRIEF DESCRIPTION OF THE DRAWINGS

Embodiments of the invention will now be described, strictly by way of example only, with reference to the accompanying drawings, of which

FIG. 1 is a schematic representation of a known NFC equipped device;

FIG. 2 is a schematic representation of an NFC equipped device according to an embodiment of the present invention; and

FIG. 3 is a sequence chart illustrating one way of saving non-volatile data to a secure element of a UICC in the device illustrated in FIG. 2.

### DESCRIPTION OF THE EMBODIMENTS

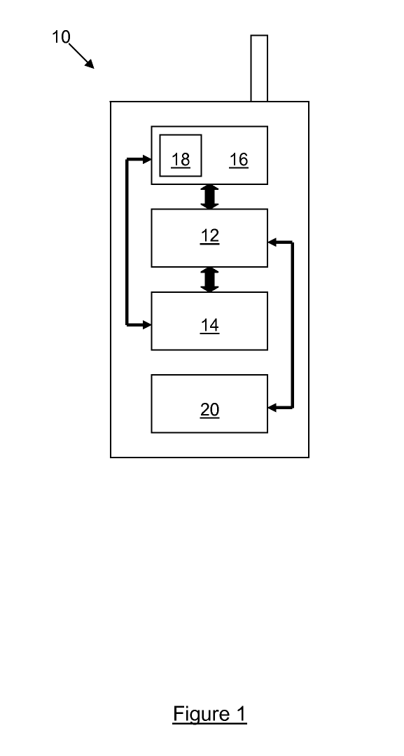

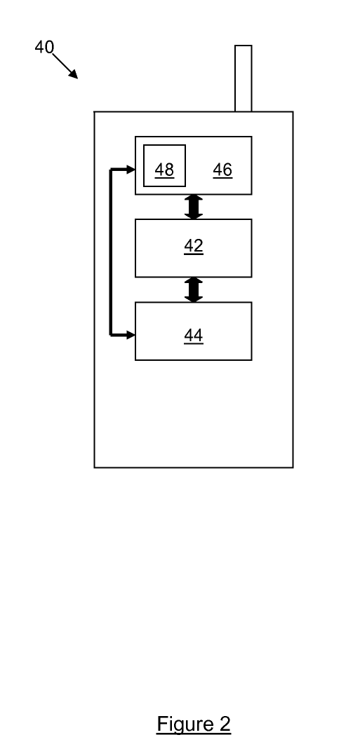

Referring first to FIG. 2, an NFC equipped device is shown generally at 40. In the embodiment illustrated in FIG. 2 the NFC equipped device 40 is a mobile telephone, and is generally similar to the device illustrated in FIG. 1, in that it includes an NFC controller 42 which is operatively connected to an application processor 44. The application processor 44 is also connected to, and communicates with, a subscriber identity module (UICC) 46, whilst the NFC controller 42 communicates with the UICC 46 using a single wire protocol (SWP) interface which implements a host controller interface (HCI) between the UICC 46 and the NFC controller 42.

The UICC 46 contains memory and data such as account information required for operation of the mobile telephone 40, and includes a secure element (SE) 48, which is a secure area of memory that is used for securely storing NFC applications and sensitive data for use by the NFC controller 42 in NFC interactions, for example credit card details.

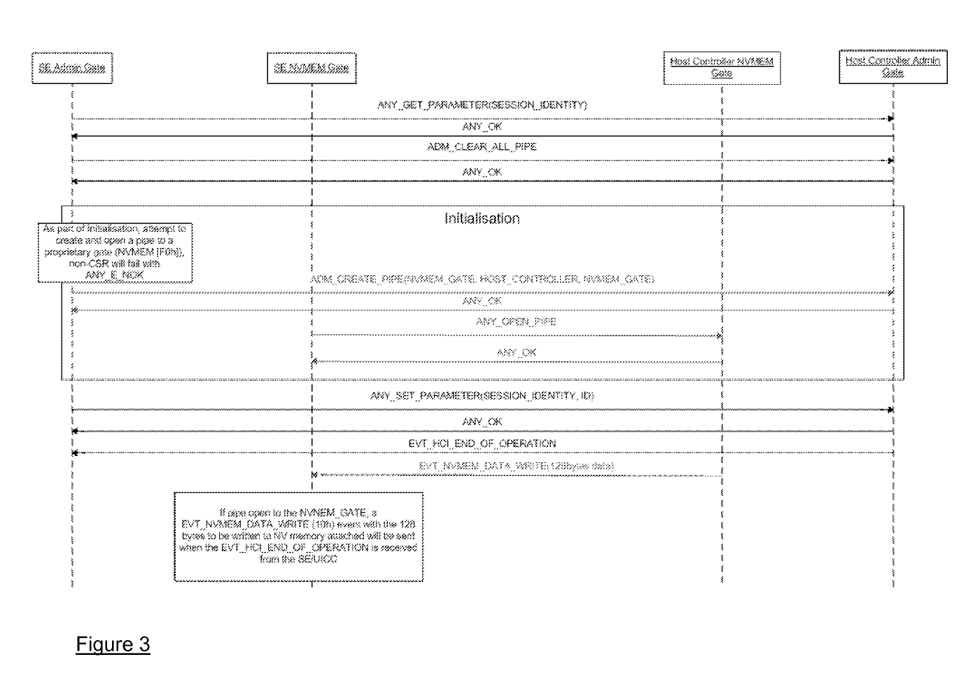

The device 40 illustrated in FIG. 2 differs from the device 10 illustrated in FIG. 1 in that there is no non-volatile memory associated with the NFC controller 42. Instead, the NFC controller 42 is configured to store non-volatile NFC data in memory of the secure element 48 by using the SWP interface between the NFC controller 42 and the UICC 46 to transfer the non-volatile NFC data to the memory of the secure element 48, and to retrieve non-volatile data stored in the memory of the secure element 48 using the SWP, as will be explained below with reference to the sequence chart of FIG. 3. Up to 128 bytes of data may be stored and retrieved in this way.

In the example illustrated in FIG. 2, the HCI on the side of the secure element 48 includes a dedicated proprietary gate known as NVMEM (for non-volatile memory) which in this example has a gate identifier value of F0. Similarly, the HCI on the side of the NFC controller 42 has a dedicated proprietary gate, also known as NVMEM.

During a first activation and initialisation of the secure element 48, for example when the NFC controller 42 is first initialised and wants to prepare to enter battery OFF mode, an SE Admin gate of the HCI on the NFC controller side attempts to create a pipe to the dedicated proprietary NVMEM gate of the secure element 48, by sending a command “ADM_CREATE_PIPE(NVMEM_GATE, HOST_CONTROLLER, NVMEM_GATE)” to an Admin gate on the secure element side.

If this pipe is successfully created (as indicated in FIG. 3 by the return message “ANY_OK” from the Admin gate on the secure element side to the SE Admin gate on the NFC controller side), the SE Admin gate on the NFC controller side HCI opens the pipe by sending an “ANY_OPEN_PIPE” command to a dedicated NVMEM gate of the secure element side HCI. The NVMEM gate on the secure element side HCI responds with an “ANY_OK” message if the pipe is successfully opened.

Once the pipe has been opened, the NVMEM gate on the NFC controller side sends a command “EVT_NVMEM_DATA_WRITE(10h)” with the 128 non-volatile data bytes to be written to the memory of the secure element 48 attached, to initiate a write event to write the non-volatile data bytes to the memory of the secure element 48.

It will be appreciated that this method of writing non-volatile NFC data to the secure element 48 can only work when the secure element includes the proprietary dedicated NVMEM gate. If a secure element 48 that does not include this proprietary dedicated NVMEM gate is used, a fail message “ANY_E_NOK” will be returned by the secure element 48 and the data will not be transferred to the secure element 48.

When the device 40 participates in an NFC transaction in card emulation mode with no battery, for example a cashless purchase or to activate a barrier at a public transport station, the 128 bytes of non-volatile data stored in the memory of the secure element 48 must be retrieved. When power is available, the same information could be cached in the RAM of the NFC controller 42. A start up sequence or process to achieve this is described below.

In a first step of this process, the NFC controller 42 detects the presence of an NFC carrier, and powers up the secure element 48 and enables the single wire protocol interface to permit input and output of data to and from the secure element 48.

The secure element 48 sends an “ACT_SYNC_ID” frame to the NFC controller 42. This is part of the normal start-up process, and allows the NFC controller 42 to identify the secure element. The NFC controller 42 responds by sending a modified “ACT_POWER_MODE” message, in which the FR bit is set to 1, to inform the secure element that the NFC controller supports the non-volatile data storage mechanism described above.

The secure element 48 interprets the “ACT_POWER_MODE” message as a request to transmit the stored non-volatile data to the NFC controller 42, and so sends four data packets each containing 32 bytes to the NFC controller 42 via the single wire protocol interface. The four data packets are followed by an “ACT_READY” message, which indicates that the secure element is ready to receive further commands. The NFC controller 42 responds with a “RSET” command to reset the data link between the secure element 48 and the NFC controller 42, to which the secure element responds with a “UA” unnumbered acknowledgement.

In the event that a secure element which does not support the non-volatile data storage mechanism described above is used with the NFC controller 42, the secure element does not interpret the “ACT_POWER_MODE” message sent by the NFC controller 42 as a request to transmit stored non-volatile data bytes, and responds by resending the “ACT_SYNC_ID” message to the NFC controller 42. The NFC controller 42 then recognises that the secure element is not compatible, and sends and “ACT_POWER_MODE” message with the FR bit set to 0, provided that the “ACT_SYNC_ID” message received from the secure element is acceptable. The secure element then sends an “ACT_READY” message, and the NFC controller 42 responds with a “RSET” command to reset the data link between the secure element 48 and the NFC controller 42, to which the secure element responds with a “UA” unnumbered acknowledgement.

Thus, in the event that an incompatible secure element is used, the NFC controller 42 recognises this and carries on with a standard start-up sequence.

In the exemplary embodiment discussed above with reference to FIGS. 2 and 3 the secure element 48 is provided as part of a UICC card 46. However, it is to be appreciated that the secure element 48 may be provided elsewhere. For example, the secure element may be provided as a separate component within the device 40, as part of the NFC controller 42, or on a memory card such as an SD card that can be removed from the device 40.

It will be appreciated that the use of the memory of the secure element 48 to store the non-volatile NFC data can help to reduce the silicon area required for the NFC controller 42, since no non-volatile memory is needed in the NFC controller 42. Additionally, as no non-volatile memory is needed outside of the NFC controller to store the non-volatile NFC data the BoM cost of the device 40 can be reduced.

The data and applications in the secure element 48 can be accessed by the NFC controller 42 in reader emulation mode even when the device 40 is powered off, since the NFC controller 42 and the secure element 48 are powered by energy harvested from the external NFC reader, thus ensuring that a user of the device 40 is not disadvantaged by a low or discharged battery.

Secure elements implement a variety of operating systems and some of these can take a significant time to boot. Therefore, in order to provide a response time of less than 5 milliseconds for retrieving the non-volatile data stored in the memory of the secure element 48 in order to meet the transaction time requirements for NFC, some changes to the boot sequence of the secure element 48 are envisaged.

For example, when starting in the battery OFF state and receiving power from the NFC controller 42 for the first time, the secure element 48 may defer booting up its main operating system for a period sufficient to permit retrieval of non-volatile data from the secure element 48 within a predetermined time period, which in this example is 5 milliseconds, but which may be a smaller time period, depending upon factors such as device requirements.

In one embodiment, the secure element 48 may wait to check for a ANY_GET_PARAMETER message before proceeding with the boot of its main operating system. This may require the secure element 48 to boot into a small operating system sufficient to respond to a ANY_GET_PARAMETER request or some other intermediate state. The key point is that the secure element 48 defers or avoids booting up its full operating system when it is most likely that the NFC controller 42 is initiating a transaction starting from the battery OFF state.

What is claimed is:

1. A near field communications (NFC) equipped device comprising:
an NFC controller for controlling NFC communication between the device and a compatible NFC reader;
a secure element for storing NFC applications and data; and
a single wire protocol interface for communication between the NFC controller and the secure element, wherein the NFC controller is configured to use the single wire protocol to write non-volatile NFC data to memory of the secure element and to read the non-volatile NFC data from the memory of the secure element.

2. A NFC equipped device according to claim 1 wherein the secure element implements a dedicated gate for transferring the non-volatile NFC data to and from the memory of the secure element.

3. A NFC equipped device according to claim 1 wherein the NFC controller implements a dedicated gate for transferring the non-volatile NFC data to and from the memory of the secure element.

4. A NFC equipped device according to claim 1 wherein the NFC equipped device comprises a mobile telephone.

5. A NFC equipped device according to claim 1 wherein the secure element is provided on a universal integrated circuit card (UICC).

6. A method of retrieving non-volatile NFC data from memory of a secure element of a NFC equipped device according to claim 1, the method comprising:
sending a modified message from the NFC controller to the secure element to indicate that the NFC controller supports retrieval of the non-volatile NFC data from the memory of the secure element; and
at the secure element, receiving the modified message and responding by transmitting the non-volatile NFC data to the NFC controller.

7. A method according to claim 6 wherein the modified message is an “ACT_POWER_MODE” message whose FR bit is set to 1.

8. A method according to claim 6 wherein the non-volatile NFC data is transmitted to the NFC controller as a plurality of data packets followed by an “ACT_READY” message.

9. A secure element for use in an NFC equipped device, the secure element including non-volatile memory, wherein the secure element implements a dedicated gate for transferring non-volatile NFC data to and from the non-volatile memory of the secure element.

10. A secure element for use in an NFC equipped device, wherein the secure element is configured to defer booting up its main operating system for a period sufficient to permit retrieval of non-volatile data from the secure element within a predetermined time period.

11. A secure element according to claim 10 wherein the predetermined time period is 5 milliseconds.

12. A secure element according to claim 10 wherein the secure element is configured to defer booting up its main operating system until it receives a message indicating that the non-volatile data has been retrieved from the secure element.

13. A secure element according to claim 12 wherein the message is a ANY_GET_PARAMETER message.
